(19) United States
(12) Patent Application Publication
(10) Pub. No.: US 2026/0232142 A1
(43) Pub. Date: Aug. 13, 2026

(54) FOOD SEASONING DELIVERY DEVICE AND METHOD

(71) Applicant: Dave Richardson, Davis, CA (US)

(72) Inventor: Dave Richardson, Davis, CA (US)

(21) Appl. No.: 18/913,822

(22) Filed: Oct. 11, 2024

(51) Int. Cl. A47J 43/16; A47J 47/01

(52) U.S. Cl. CPC A47J 43/16; A47J 47/01

(57) ABSTRACT

A food seasoning device is disclosed. The food seasoning device includes a rod, a handle coupled to the rod, and a tube configured to accommodate and guide the movement of the rod through a hollow center of the tube, that includes a notched opening that is configured to accommodate seasonings and a beveled end region that is configured to cause incisions.

### TECHNICAL FIELD

Embodiments of the disclosure pertain to food seasoning devices, and in particular, to food seasoning delivery devices.

### BACKGROUND

Seasoning food is the process of supplementing food via herbs, spices, salts, and/or sugar, in a manner intended to enhance flavor. Seasoning food can include adding large or small amounts of seasonings to food preparations. In particular, seasoning substances such as salt can be used to magnify the natural flavor of a food, making it either richer, or more delicate. For instance, sea salt (a coarser-grained salt) can be rubbed into chicken, lamb, and beef to tenderize the meat and improve flavor. Other seasonings like black pepper and basil are also used to add flavor to food. Many seasonings are added near the end of the cooking period, or even at the table, when the food is served. The most common table-seasonings are salt, pepper, and acids (such as lemon juice). Conventional methods of seasoning food are predominantly surface based, which limits the achievable depth of flavor infusion and culinary creativity.

### BRIEF DESCRIPTION OF THE DRAWINGS

FIG. 1A shows a person using a seasoning delivery device configured according to one embodiment.

FIG. 1B shows components of the seasoning delivery device according to one embodiment.

FIG. 1C shows a side view of a subject foodstuff that has been readied for seasoning.

FIG. 1D shows the subject foodstuff of FIG. 1C after it has been penetrated with the seasoning delivery device.

FIG. 1E shows a seasoning delivery device with its rod retracted in a manner that unblocks its seasoning loading slot.

FIG. 1F shows a seasoning delivery device after seasoning has been pushed forward until it is positioned in the beveled end region of the seasoning delivery device.

FIG. 1G shows the delivery of a second seasoning to a second intended seasoning delivery location.

FIG. 1H shows the positioning of a third seasoning at a third intended seasoning delivery location.

FIG. 2 shows a method for forming a seasoning delivery device according to one embodiment.

### DESCRIPTION OF THE EMBODIMENTS

A food seasoning delivery device is described. It should be appreciated that although embodiments are described herein with reference to example food seasoning delivery devices, the disclosure is applicable to food seasoning delivery devices in general as well as other kinds of food seasoning delivery devices. In the following description, numerous specific details are set forth, in order to provide a thorough understanding of embodiments of the present disclosure. It will be apparent to one skilled in the art that embodiments of the present disclosure may be practiced without these specific details. In other instances, well-known features, are not described in detail in order to not unnecessarily obscure embodiments of the present disclosure. Furthermore, it is to be appreciated that the various embodiments shown in the Figures are illustrative representations and are not necessarily drawn to scale.

Certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

As used herein, the terms “seasoning” and “seasonings” when employed as a noun is intended to refer to a seasoning element or seasoning source such as herbs, spices, salts, sugar, fruit, vegetables, etc. (see description herein below).

Seasoning food is the process of supplementing food with herbs, spices, salts, and/or sugar, in a manner intended to enhance flavor. Seasoning food can include adding large or small amounts of seasonings to food preparations. In this manner, a seasoning substance such as salt can be used to magnify the natural flavor of a food, making it either richer, or more delicate. For instance, sea salt (a coarser-grained salt) can be rubbed into chicken, lamb, and beef to tenderize the meat and improve flavor. Other seasonings like black pepper and basil are also used to add flavor to the food. Many seasonings are added near the end of the cooking period, or even at the table, when the food is served. The most common table-seasonings are salt, pepper, and acids (such as lemon juice). Conventional methods of seasoning food are predominantly surface based, which limits the achievable depth of flavor infusion and culinary creativity.

A seasoning delivery device is disclosed that addresses the shortcomings of conventional methods of seasoning food. The food seasoning device includes a rod, a handle coupled to the rod, and a tube configured to accommodate and guide the movement of the rod through a hollow center of the tube, that includes a notched opening that is configured to accommodate seasonings and a beveled end region that is configured to cause incisions. In one embodiment, the seasoning delivery device provides users with the capacity to deploy seasoning as desired within foodstuffs. It enables users to overcome limitations of conventional seasoning processes that are surface oriented. In particular, it enables the achievable depth of flavor infusion to be increased. And it provides users with the capacity to deploy seasoning as desired, enabling users to create seasoning configurations to more precisely suit taste.

### Seasoning Delivery Device Operating Environment

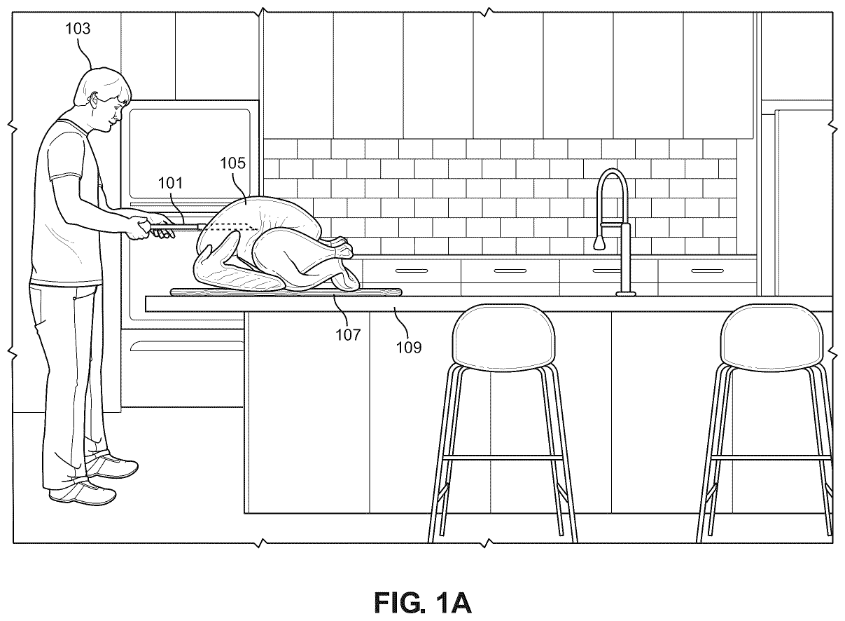

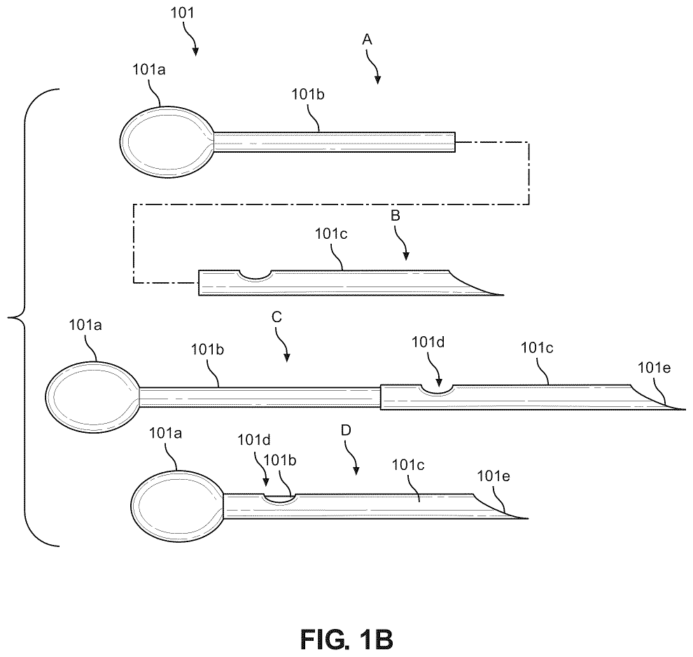

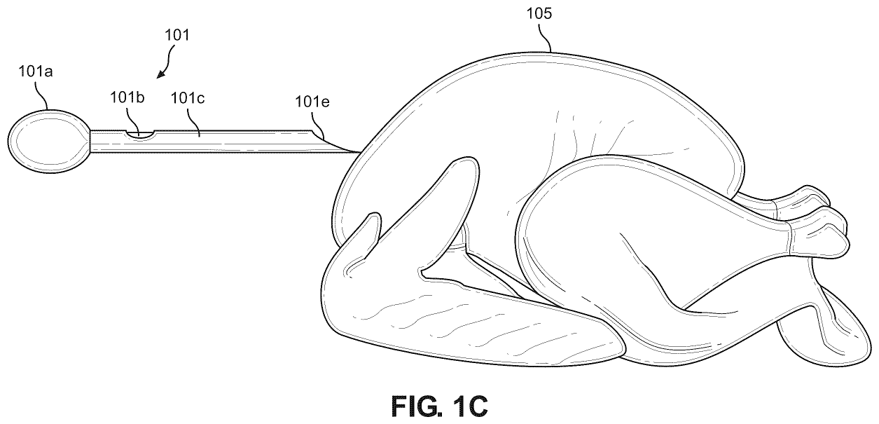

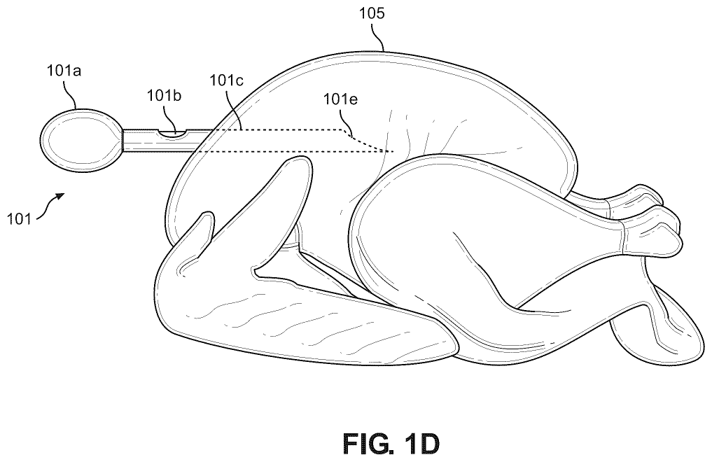

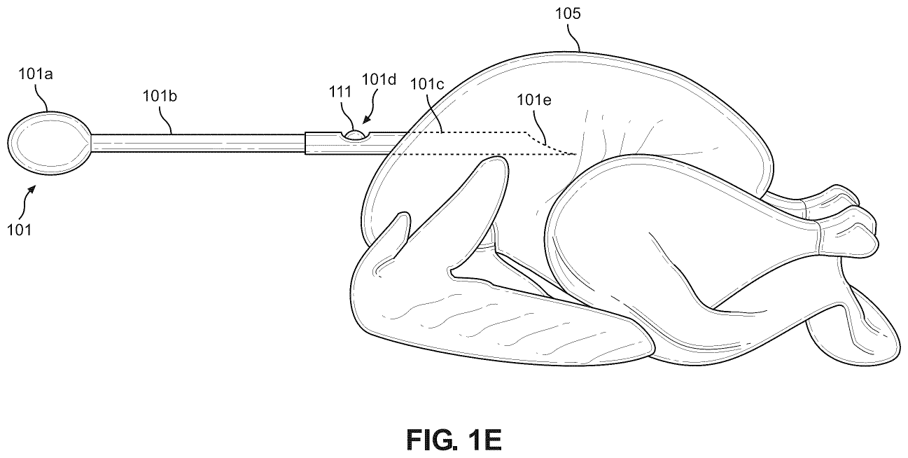

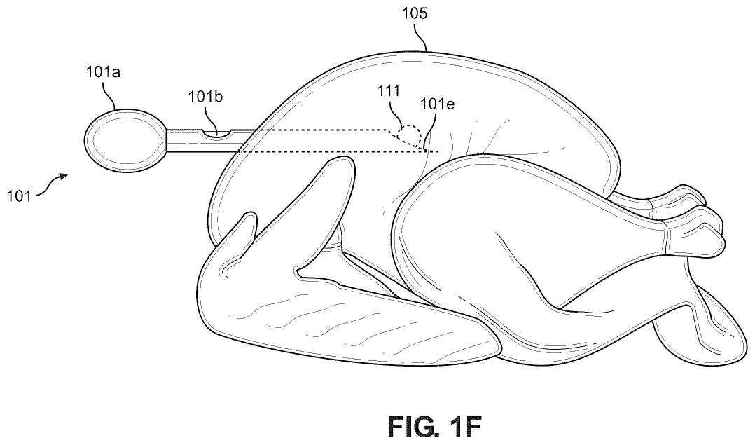

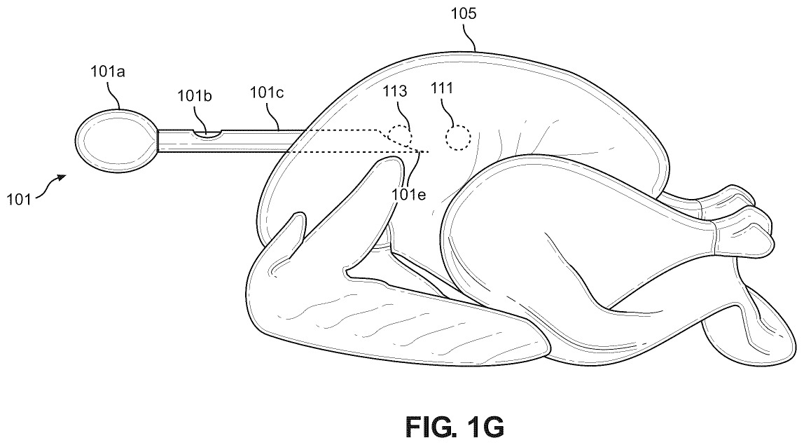

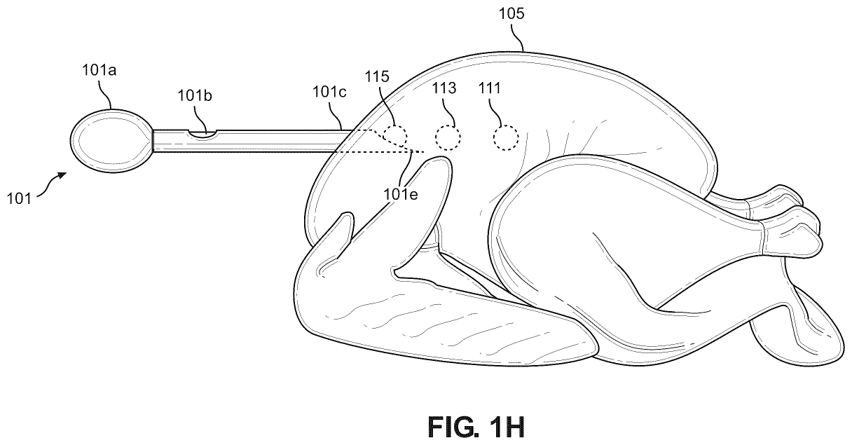

FIG. 1A depicts a kitchen where a person is shown using a seasoning delivery device to season foodstuff situated on the kitchen counter. FIG. 1A shows seasoning delivery device 101, user 103, foodstuff 105, cutting board 107 and counter 109. It should be appreciated that although a kitchen is shown, the seasoning process can be carried out in many other environments.

Referring to FIG. 1A, the user 103 is able to use the seasoning delivery device 101 to deliver seasoning to desired locations within the foodstuff 105. In one embodiment, seasoning delivery device 101 can be used to prepare the foodstuff 105 for cooking. By using the seasoning delivery device 101, seasoning can be delivered to precise locations within the foodstuff 105 such that the foodstuff 105 can be seasoned in a desired manner.

In one embodiment, foodstuffs can include but are not limited to beef roasts, pork loin roasts, bison roasts, sausage links, turkey breasts, ham, meatloaf and bread dough. In one embodiment, any type of foodstuff that is amenable to seasoning with the seasoning delivery device 101 can be seasoned with the seasoning delivery device 101.

In one embodiment, seasonings can include solid seasonings that include but are not limited to garlic, onion, dried apricots, dried cranberries, dried cherries, dried tomatoes, dried mushrooms, dried pineapple, sage, fresh rosemary, bacon, pine nuts, pistachios, walnuts, almonds, cashews, peppercorns, salts, hot peppers, kalamata olives, chilled butter, thick jams, different cheeses, cilantro, coconut, orange peel, chocolate, and coffee beans. In other embodiments, seasonings can include seasonings other than solid seasonings. In one embodiment, seasonings can include any type of seasoning that is desired by the user.

### Seasoning Delivery Device Components

FIG. 1B shows components of the seasoning delivery device 101 according to one embodiment. In the FIG. 1B embodiment, seasoning delivery device 101 includes, as shown at A, ball handle 101a, and rod 101b. And at B, tube 101c. And at C, seasoning loading slot 101d, and beveled end region 101e.

Referring to FIG. 1B, the handle 101a is a part of the seasoning delivery device 101 that can be grasped to either retract the rod 101b, or move the rod 101b forward. In one embodiment, the rod 101b, can be retracted to allow seasoning to be loaded into the seasoning delivery device 101, or pushed forward in order to put seasoning into its beveled end region 101e. The rod 101b extends from the handle 101a and is moveable within the tube 101c. In one embodiment, the rod 101b can operate as a plunger that can move seasoning within the tube 101c and position the seasoning within the beveled end region 101e of the seasoning delivery device 101. In one embodiment, in use, the force applied to the handle 101a is transferred to the beveled end region 101e of the tube 101c to facilitate the penetration of the foodstuff 105 and the depositing of seasoning therein. After the rod 101b is used to push the seasoning through the opening located at the end of the tube 101c, the seasoning can be deposited therefrom within the foodstuff 105. In one embodiment, the rod 101b can be formed from stainless steel. In other embodiments, the rod 101b may not be formed from stainless steel. In one embodiment, the rod 101b can be formed from any suitable material that will enable it to penetrate foodstuffs.

The tube 101c is a cylindrical component having an elongated body that includes a beveled end region 101e. The tube 101c is configured to accommodate, and guide the movement of, the rod 101b, through its hollow center region. In one embodiment, the tube 101c includes a seasoning loading slot 101d for loading seasoning that is to be deposited at desired locations within foodstuffs (e.g., 105 in FIG. 1A). In one embodiment, the beveled end region 101e is configured to cut into the foodstuffs to form an opening through which the seasoning delivery device 101 can penetrate the physical body of the foodstuffs. In one embodiment, the tube 101c is configured to guide the rod 101b, and the seasoning that the rod 101b impels, into place on the beveled end region 101e. The tube 101c is configured to ensure that loaded seasoning can be delivered to desired locations at desired depths within the foodstuff (e.g., 105 in FIG. 1A). The described design of the tube 101c enables quick and efficient insertion of seasoning into foodstuffs.

The seasoning loading slot 101d is an opening in the tube 101c through which seasonings can be placed. In one embodiment, the seasoning loading slot 101d can be configured as a notch that is formed in an upper surface of the tube 101c. In other embodiments, the seasoning loading slot 101d may not be formed in an upper surface of the tube but can be formed in other parts of the tube in any manner that is suitable for loading seasoning into the tube 101c.

The beveled end region 101e is configured to incise or pierce subject foodstuffs and to perform the necessary cutting that facilitates the insertion and penetration of the subject foodstuffs, by the seasoning delivery device 101. In one embodiment, this enables the seasoning delivery device 101 to precisely deliver seasonings to desired locations.

### Operation

FIGS. 1C-1H show operations performed as part of a process of delivering seasoning to desired locations within foodstuffs.

FIG. 1C depicts a side view of a subject foodstuff (a turkey) that has been readied for seasoning. Initially, as shown in FIG. 1C, the seasoning delivery device 101 is positioned to contact a part of the surface of the subject foodstuff prior to penetration. In one embodiment, the penetration direction of the seasoning delivery device 101 is chosen based on the intended seasoning delivery location(s). In one embodiment, the beveled end region 101e of the seasoning delivery device 101 is placed against the surface of the subject foodstuff 105 (typically uncooked) at an angle that directs the seasoning delivery device 101 toward the intended seasoning delivery location. In one embodiment, at this stage, the rod 101b of the seasoning delivery device 101 should be fully inserted into the tube 101c (it should not be retracted).

FIG. 1D shows the subject foodstuff 105 of FIG. 1C after the subject foodstuff 105 has been penetrated with the seasoning delivery device 101 to a position at which the user intends to deposit/deliver the seasoning. In one embodiment, the position can be ½ inch from an end of the subject foodstuff 105. In other embodiments, the position can be any position that is determined by the user of the seasoning delivery device 101 that is desirable. In one embodiment, the subject foodstuff 105 can be penetrated by holding the subject foodstuff 105 in place while pushing the seasoning delivery device 101 forward. For example, while twisting the seasoning delivery device 101 back and forth such that even tough parts of the subject foodstuff 105 can be readily penetrated.

FIG. 1E shows the seasoning delivery device 101 with the rod 101b retracted in a manner that unblocks the seasoning loading slot 101d of the tube 101c. In one embodiment, this enables seasoning 111 to be loaded into the seasoning loading slot 101d as shown in FIG. 1E. In one embodiment, the seasoning 111 can be precut solid seasoning. In other embodiments, the seasoning can be other forms of seasoning that are loadable into seasoning loading slot 101d.

FIG. 1F shows the seasoning delivery device 101 after the loaded seasoning 111 has been pushed forward by the rod 101b and positioned in the beveled end region 101e of the tube 101c. In one embodiment, the loaded seasoning 111 is pushed forward by the rod 101b until the handle 101a that is attached to the rod 101b contacts the end of the tube 101c. In one embodiment, with the seasoning positioned in the beveled end region 101e of the seasoning delivery device 101, the seasoning can be released from the beveled end region 101e into the foodstuff 105 at the intended seasoning delivery site. In one embodiment, the seasoning can be released from the beveled end region 101e into the foodstuff 105 at the intended seasoning delivery site by pulling the seasoning delivery device 101 backward. In one embodiment, the seasoning delivery device 101 can be pulled backward by 1/2 inch to place the end of the seasoning delivery device at a next insertion location or intended seasoning delivery site. In other embodiments, the seasoning delivery device can be pulled backward by any distance desired by the user.

FIG. 1G shows the delivery of a second seasoning element 113 to a second intended seasoning delivery site. In one embodiment, as shown in FIG. 1G, the second seasoning element 113 is deposited into the subject foodstuff 105 via the beveled end region 101e at the second intended seasoning delivery site in the subject foodstuff 105 without removing the seasoning delivery device 101 from the subject foodstuff 105. For example, after the end of the seasoning delivery device 101 is moved from the first intended seasoning delivery site to the second intended delivery site, the operations of FIG. 1E and FIG. 1F can be repeated to affect the lodging of the second seasoning element 113 at the second intended seasoning delivery site.

FIG. 1H shows the delivery of a third seasoning element 115 to a third intended seasoning delivery site. In one embodiment, as shown in FIG. 1H, the third seasoning element 115 is deposited into the subject foodstuff 105 via the beveled end region 101e at the third intended seasoning delivery site in the subject foodstuff 105 without removing the seasoning delivery device 101 from the subject foodstuff 105. For example, after the end of the seasoning delivery device 101 is moved from the second intended seasoning delivery site to the third intended delivery site, the operations of FIG. 1E and FIG. 1F can be repeated to affect the lodging of the third seasoning element 115 at the third intended seasoning delivery site.

It should be noted that additional rows of seasoning (as many as desired) can be formed using the seasoning delivery device 101 as described above. However, it should be noted that the seasoning delivery device 101 is not limited to forming rows of seasoning but can deliver seasoning to any place that is desired within the subject foodstuff.

In one embodiment, using the process described above, the seasoning delivery device 101 provides users with the capacity to deploy seasoning as desired within foodstuffs. It enables users to overcome limitations of conventional seasoning processes that are surface oriented. In particular, it enables the achievable depth of flavor infusion to be increased. And, it provides users with the capacity to deploy seasoning as desired, enabling users to create seasoning configurations to more precisely suit taste.

### Method for Forming a Seasoning Delivery Device

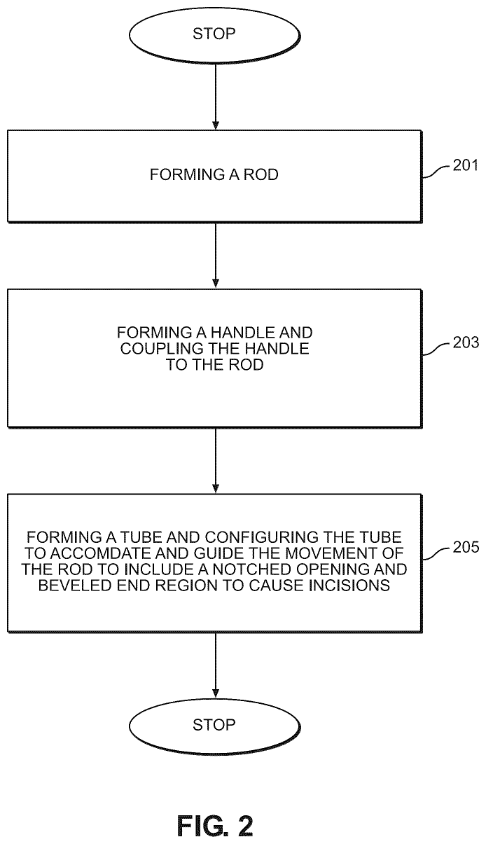

FIG. 2 shows a method for forming a seasoning delivery device according to one embodiment. The method includes, at 201, forming a rod. In one embodiment, as part of forming the rod, a sturdy material of round stock can be cut to a predetermined length. In one embodiment, the sturdy material can be metal. In other embodiments, the sturdy material can be nonmetallic. In one embodiment, the sturdy material can be steel. In other embodiments, the sturdy material may not be steel. The method further includes, at 203, forming a handle coupled to the rod. In one embodiment, the handle can be formed by shaping material into a ball. In other embodiments, the handle can be formed by shaping material into a shape other than a ball. In one embodiment, the handle can be formed by grinding. In other embodiments, the handle can be formed by a process other than grinding. In one embodiment, the handle can be attached to the rod by welding. In other embodiments, the handle can be attached to the rod by methods other than welding. In one embodiment, after the handle is attached to the rod, the handle and rod can be polished. In other embodiments, after the handle is attached to the rod, the handle and rod may not be polished.

Referring again to FIG. 2, the method also includes, at 205, forming a tube that is configured to accommodate and guide the movement of the rod through a hollow center of the tube, that includes a notched opening that is configured to accommodate seasonings and a beveled end region that is configured to cause incisions.

In one embodiment, forming the tube can include forming the notched opening or slot in the tube by a process that can include grinding or milling. In other embodiments, forming the tube can include forming the notched opening or slot by a process other than grinding or milling. In one embodiment, forming the tube can include, forming the beveled end by causing the end of the tube to have a sloped edge. In one embodiment, the sloped edge may have an angle of 60 degrees. In other embodiments, the sloped edge may have other angles. In one embodiment, the rod and/or the handle can be polished. In other embodiments, the rod and/or the handle may not be polished. In one embodiment, the tube can be polished. In other embodiments, the tube may not be polished. In one embodiment, slot and/or end of the tube can be deburred. In other embodiments, the slot and/or the end of the tube may not be deburred.

In one embodiment, the rod is configured to push the seasonings into the beveled end region of the tube. In one embodiment, the beveled end region is configured to enable a penetration of subject foodstuffs. In one embodiment, the beveled end region is configured to facilitate the positioning of the seasonings at determined locations within subject foodstuffs. In one embodiment, the notched opening is configured to expose the hollow center of the tube when the rod is retracted. In one embodiment, the notched opening is configured to receive seasonings when the rod is retracted. In one embodiment, the notched opening is formed on the upper surface of the tube.

The following examples pertain to further embodiments. The various features of the different embodiments may be variously combined with some features included and others excluded to suit a variety of different applications.

Example embodiment 1: A device, comprising: a rod; a handle coupled to the rod; and a tube configured to accommodate and guide the movement of the rod through a hollow center of the tube, that includes a notched opening that is configured to accommodate seasonings and a beveled end region that is configured to cause incisions.

Example embodiment 2: The device of example embodiment 1, wherein the rod is configured to push the seasonings into the beveled end region of the tube.

Example embodiment 3: The device of example embodiment 1, wherein the beveled end region is configured to enable a penetration of subject foodstuffs.

Example embodiment 4: The device of example embodiment 1, wherein the beveled end region is configured to facilitate the positioning of the seasonings at determined locations within subject foodstuffs.

Example embodiment 5: The device of example embodiment 1, wherein the notched opening exposes the hollow center of the tube when the rod is retracted.

Example embodiment 6: The device of example embodiment 1, wherein the notched opening is configured to receive seasonings when the rod is retracted.

Example embodiment 7: The device of example embodiment 1, wherein the notched opening is located on the upper surface of the tube.

Example embodiment 8: A method for forming a device, comprising: forming a rod; forming a handle coupled to the rod; and forming a tube configured to accommodate and guide the movement of the rod through a hollow center of the tube, that includes a notched opening that is configured to accommodate seasonings and a beveled end region that is configured to cause incisions.

Example embodiment 9: The method of example embodiment 8, wherein the rod is configured to push the seasonings into the beveled end region of the tube.

Example embodiment 10: The method of example embodiment 8, wherein the beveled end region is configured to enable a penetration of subject foodstuffs.

Example embodiment 11: The method of example embodiment 8, wherein the beveled end region is configured to facilitate the positioning of the seasonings at determined locations within subject foodstuffs.

Example embodiment 12: The method of example embodiment 8, wherein the notched opening exposes the hollow center of the tube when the rod is retracted.

Example embodiment 13: The method of example embodiment 8, wherein the notched opening is configured to receive seasonings when the rod is retracted.

Example embodiment 14: The method of example embodiment 8, wherein the notched opening is located on the upper surface of the tube.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of the present disclosure. The scope of the present disclosure includes any feature or combination of features disclosed herein (either explicitly or implicitly), or any generalization thereof, whether or not it mitigates any or all of the problems addressed herein. Accordingly, new claims may be formulated during prosecution of the present application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The various features of the different embodiments may be variously combined with some features included and others excluded to suit a variety of different applications.

What is claimed is:

1. A food seasoning device, comprising:
a rod;
a handle coupled to the rod; and
a tube configured to accommodate and guide a movement of the rod through a hollow center of the tube, that includes a notched opening that is configured to accommodate seasonings and a beveled end region that is configured to cause incisions.

2. The device of claim 1, wherein the rod is configured to push the seasonings into the beveled end region of the tube.

3. The device of claim 1, wherein the beveled end region is configured to enable a penetration of subject foodstuffs.

4. The device of claim 1, wherein the beveled end region is configured to facilitate positioning of the seasonings at determined locations within subject foodstuffs.

5. The device of claim 1, wherein the notched opening exposes the hollow center of the tube when the rod is retracted.

6. The device of claim 1, wherein the notched opening is configured to receive seasonings when the rod is retracted.

7. The device of claim 1, wherein the notched opening is located on an upper surface of the tube.

8. A method for forming a food seasoning device, comprising:
forming a rod;
forming a handle coupled to the rod; and
forming a tube configured to accommodate and guide a movement of the rod through a hollow center of the tube, that includes a notched opening that is configured to accommodate seasonings and a beveled end region that is configured to cause incisions.

9. The method of claim 8, wherein the rod is configured to push the seasonings into the beveled end region of the tube.

10. The method of claim 8, wherein the beveled end region is configured to enable a penetration of subject foodstuffs.

11. The method of claim 8, wherein the beveled end region is configured to facilitate a positioning of the seasonings at determined locations within subject foodstuffs.

12. The method of claim 8, wherein the notched opening exposes the hollow center of the tube when the rod is retracted.

13. The method of claim 8, wherein the notched opening is configured to receive seasonings when the rod is retracted.

14. The method of claim 8, wherein the notched opening is located on an upper surface of the tube.
